(19) United States
(12) Patent Application Publication
(10) Pub. No.: US 2013/0344577 A1
(43) Pub. Date: Dec. 26, 2013

(54) LIQUID CRYSTAL BASED SENSOR DEVICES FOR DETECTING TOXINS, BACTERIA AND THEIR ACTIVITIES

(71) Applicant: SONY CORPORATION, Tokyo (JP)

(72) Inventors: Pinar KILICKIRAN, Stuttgart (DE); Zakir HUSSAIN, Stuttgart (DE); Akira MASUTANI, Stuttgart (DE); Nadine HOLLFELDER, Stuttgart (DE); Gabriele NELLES, Stuttgart (DE)

(73) Assignee: SONY CORPORATION, Tokyo (JP)

(21) Appl. No.: 13/893,607

(22) Filed: May 14, 2013

(30) Foreign Application Priority Data
Jun. 20, 2012 (EP) 12172777.0

(51) Int. Cl. G01N 27/26

(52) U.S. Cl. CPC G01N 27/26
USPC 435/287.1

(57) ABSTRACT

A liquid crystal based sensor device for detecting analytes. A method of manufacturing liquid crystal based sensor devices for detecting analytes. A method for at least one of (i) detecting analytes with a liquid crystal based sensor device; (ii) detecting the activity of analytes; and (iii) detecting screening compounds binding to analytes and/or modifying their activity.

### CROSS REFERENCE TO RELATED APPLICATIONS

The present application claims priority to European Application 12 172 777.0, filed on 20 Jun. 2012, the contents of which being incorporated herein by reference in its entirety.

### BACKGROUND

1. Field of the Disclosure

The present disclosure relates to liquid crystal based sensor devices for detecting analytes. In particular, the present disclosure relates to methods of manufacturing liquid crystal based sensor devices for detecting analytes. Furthermore, the present disclosure relates to uses of liquid crystal based sensor devices for detecting analytes, the activity of analytes and for screening compounds binding to analytes and/or modifying their activity.

2. Description of Related Art

Liquid crystals are materials that can exhibit the mobility of liquids and the anisotropy of solid crystals. Thermotropic liquid crystals have demonstrated utility in the transduction of molecular events at an interface into macroscopic responses visible with the naked eye. The long-range orientational order and optical anisotropy of LC molecules can transform chemical and biomolecular binding events into amplified optical signals that can be easily observed, even with naked eye. Interfaces between thermotropic LCs and immiscible aqueous phases have received substantial recent attention owing to the strong coupling that can occur between the ordering of the LCs and organization of assemblies of molecules that can be formed at these interfaces. These properties, combined with the optical anisotropy of LC molecules, make them well-suited for the direct transduction and amplification of the binding of an analyte to a target at an interface into an optical output. Most of the current methods for the detection of biological analytes require laboratory-based analytical detectors and labeled species such as fluorophores or radioactive isotopes and therefore, it is of great potential for providing highly sensitive and low-cost bioassays performed away from central laboratories without the need of sophisticated instrumentation.

The self-assembly of surfactants, lipids, and polymers at these interfaces is strongly coupled to the ordering of the LCs, and that the presence and organization of these molecules can be reported through changes in the optical appearance of the LCs. It has also been reported that more complex interfacial phenomena, such as specific binding events involving proteins, bacteria, viruses, enzymatic reactions, hybridization of DNA, and the culture of human embryonic stem cells at aqueous-LC interfaces can trigger dynamic orientational transitions in the LCs. These studies suggest that aqueous-LC interfaces define a promising class of biomolecular interfaces for reporting interfacial phenomena.

The principles of LC-based detection rely on optical, anchoring, and the elastic properties arising from molecular anisotropies and the unique liquid-crystalline phase of the LC material. The molecular anisotropy of a liquid crystalline sample creates a difference in the refractive indices of light parallel and perpendicular to the bulk molecular orientation, i.e., the LC director. Molecular-scale interactions between an LC and a neighboring interface result in a preferred anchoring angle relative to the surface normal. Information about the interface, in the form of surface anchoring, is transmitted as far as 100 μm into the bulk as a result of the elastic nature of the LC director field.

### SUMMARY

It is therefore an object of the present disclosure to provide sensor devices for detecting analytes as well as the activity of analytes that are simply and easy to use.

The objects of the present disclosure are solved by a sensor device for detecting the presence of an analyte, such as a prokaryotic cell, such as a bacterial cell, and/or a procaryotic agent, such as a toxin, such as a bacterial toxin, said device comprising, in the following order:
a first substrate,
a liquid crystal layer on said first substrate,
a phospholipid layer on said liquid crystal layer,
   wherein said device does not comprise a recognition moiety or molecule that is directly attached to the surface of said first substrate.

It is another object of the present disclosure to provide a method of manufacturing a sensor device for detecting analytes that includes:
a) providing a first substrate,
b) depositing a liquid crystal layer on said first substrate,
c) depositing a phospholipid layer on said liquid crystal layer, optionally comprising at least one recognition moiety/molecule, such as a receptor, and/or cholesterol.

One embodiment of the disclosure includes a sensor device for detecting analytes as well as the activity of analytes.

One embodiment includes a sensor device for detecting the presence of an analyte, said device comprising a first substrate, a liquid crystal layer on said first substrate, a phospholipid layer on said liquid crystal layer, which not comprise a recognition moiety or molecule that is directly attached to the surface of said first substrate.

In a preferred embodiment, the phospholipid layer comprises at least one recognition moiety or molecule.

In a preferred embodiment the phospholipid layer comprises cholesterol.

In a preferred embodiment, the phospholipid layer comprises at least one of a receptor and cholesterol.

In an embodiment, the at least one recognition moiety or molecule is embedded in said phospholipid layer.

In an embodiment, the phospholipid layer comprises between about 1 to about 20% (by weight) of cholesterol.

In one embodiment, the sensor device further includes at least a first electrode between said first substrate and said liquid crystal layer, and an insulating layer and/or an alignment layer, or an insulating and alignment layer, coating said electrode.

In one embodiment, the sensor device further includes a second substrate, located opposite to said first substrate and sandwiching said liquid crystal layer and said phospholipid layer between said first and second substrate, and wherein there is a gap between said second substrate and said phospholipid layer, which gap acts as a reaction chamber for receiving a sample to be analysed.

In one embodiment, a second substrate further includes a second electrode on said second substrate, and optionally, an insulating layer on said second electrode, wherein said insulating layer faces said phospholipid layer/liquid crystal layer located on said first substrate.

In one embodiment, a second substrate further includes a second electrode on said second substrate, and an insulating layer on said second electrode, wherein said insulating layer faces said phospholipid layer/liquid crystal layer located on said first substrate.

In one embodiment, the sensor device includes a second electrode but no first electrode.

In one embodiment, the sensor device comprises a first substrate, a liquid crystal layer on said first substrate, a phospholipid layer on said liquid crystal layer, a second substrate, located opposite to said first substrate and sandwiching said liquid crystal layer and said phospholipid layer between said first and second substrate, and wherein there is a gap between said second substrate and said phospholipid layer, which gap acts as a reaction chamber for receiving a sample to be analysed.

In one embodiment, the sensor device comprises a first substrate, a liquid crystal layer on said first substrate, a phospholipid layer on said liquid crystal layer, a second substrate, located opposite to said first substrate and sandwiching said liquid crystal layer and said phospholipid layer between said first and second substrate, and wherein there is a gap between said second substrate and said phospholipid layer, which gap acts as a reaction chamber for receiving a sample to be analysed, and a second electrode on said second substrate, or a second electrode on said second substrate and an insulating layer on said second electrode, wherein said insulating layer faces said phospholipid layer/liquid crystal layer located on said first substrate.

In one embodiment, the first and/or second substrate is a solid.

In one embodiment, the first and/or second substrate is a glass or plastic.

In one embodiment, the first and/or second substrate is a plastic selected from the group of cycloolefin polymer (COP), cycloolefin copolymer (COC) and polydimethyl siloxane (PDMS).

In one embodiment, the liquid crystal layer has a homeotropic alignment, homogeneous alignment, or no pre-defined alignment.

In one embodiment, the liquid crystal layer comprises a liquid crystal selected from thermotropic liquid crystals with positive/negative/or no dielectric anisotropy, dual-frequency liquid crystals, discotic and/or lyotropic liquid crystals, and combinations of the foregoing.

In one embodiment, the liquid crystal layer comprises a single liquid crystal compound or a mixture of two or more different liquid crystal compounds, or a liquid crystal mixture mixed with dopants, such as nanoparticles or small organic molecules, such as bent-core organic molecules.

In one embodiment, the liquid crystal layer is dye doped, preferably with dichroic dye(s), fluorescent dye(s), or doped with quantum dot(s).

In one embodiment, the liquid crystal layer is dye doped with at least one of a dichroic dye, a fluorescent dye and quantum dot(s).

In one embodiment, the liquid crystal layer comprises at least one of 5CB or MLC6608 liquid crystals.

In one embodiment, the phospholipid layer comprises a single phospholipid compound or a mixture of two or more different phospholipid compounds.

In one embodiment, the at least one recognition moiety or molecule comprised in said phospholipid layer is a receptor.

In one embodiment, the phospholipid layer comprises between about 0.1% to about 10% (by weight) of GM₁.

In one embodiment, said first electrode and said second electrode, independently at each occurrence, is a non-interdigitated, plain electrode or an interdigitated electrode (IDE).

In one embodiment, the insulating layer on the first and/or second electrode is made of polyimide.

In one embodiment, the alignment layer is made of a silane.

In one embodiment, the alignment layer is made of a heat/photo-curable polyimide.

In one embodiment, the alignment layer provides for a defined pre-tilt angle of the liquid crystal in the liquid crystal layer.

In one embodiment, the alignment layer provides a self assembled monolayer of self assembling compounds.

In one embodiment, the first and/or second electrode, is/are transparent or non-transparent, wherein.

In one embodiment, the device further comprises crossed polarizers below and above the liquid crystal layer.

In one embodiment, the device further comprises means to measure an electrical quantity which means allows to measure changes in the liquid crystal alignment by measuring changes in such electrical quantity.

In one embodiment, the device further comprises one polarizer only.

In one embodiment, the device further comprises one polarizer only in the plane of either the first or the second substrate, and wherein the respective other substrate without a polarizer is for use in conjunction with a light source providing polarised light, such as a liquid crystal display device.

In one embodiment, the device further comprises a microfluidic device in fluidic connection with the reaction chamber.

In one embodiment, the device further comprises a filtering unit to filter any material from the sample that might be larger in size than the analyte of interest.

In one embodiment, the reaction chamber has a depth in the range from 800 nm to 100 μm, and has a width or diameter, in case of a round chamber, in the range of 1 μm to 1 mm.

In one embodiment, the sensor device further includes at least one polariser above the liquid crystal layer and the substrate underneath the liquid crystal layer is a reflective substrate.

In one embodiment, the sensor device further includes two crossed polarizers below and above the liquid crystal layer in the planes of the first and second substrate, respectively, that allow to measure changes in the liquid crystal alignment by measuring changes of transmission/reflection of polarized light.

In one embodiment, the sensor device further includes at least one polariser above the liquid crystal layer and wherein the substrate underneath the liquid crystal layer is a reflective substrate.

In one embodiment, the sensor device further includes a filter capable of excluding material that is larger in size than the analyte.

The objects of the present disclosure are also solved by a method of manufacturing a liquid crystal sensor device according to the present disclosure, said method comprising:
a) providing a first substrate,
b) depositing a liquid crystal layer on said first substrate,
c) depositing a phospholipid layer on said liquid crystal layer.

In one embodiment, the method further comprises
a′) depositing on said first substrate at least a first electrode, and
a″) depositing an insulating layer and/or an alignment layer, or an insulating and alignment layer, coating said first electrode.

In one embodiment, the method further comprises the additional step:
d) providing a second substrate and putting it on top of said phospholipid layer, such that said phospholipid layer and said liquid crystal layer are sandwiched between said first and second substrate, wherein there is a gap between said second substrate and said phospholipid layer, which gap acts as a reaction chamber for receiving a sample to be analysed.

In one embodiment, said second substrate has a second electrode located on it, and wherein step e) is performed such that said second electrode is facing said phospholipid layer/liquid crystal layer.

The objects of the present disclosure are also solved by a method of using the liquid crystal sensor device of the present disclosure for detecting the presence of an analyte or the activity of an analyte, said method comprising the steps:
a) providing a liquid crystal sensor device according to the present disclosure,
b) adding a sample to be analyzed onto the phospholipid layer of said liquid crystal sensor device,
c) examining for a binding event, an analyte to be detected or the activity of an analyte, based on changes induced by said binding event, analyte or activity of analyte, to the alignment of the liquid crystals in said liquid crystal layer.

In one embodiment, a binding event is the binding of the analyte to the recognition moiety or molecule comprised in said phospholipid layer.

In one embodiment, said binding event is the binding of the analyte to the phospholipid layer.

In one embodiment, said activity of an analyte is the reaction of the analyte with the recognition moiety or molecule comprised in said phospholipid layer.

In one embodiment, said activity of an analyte is the reaction of the analyte with the phospholipid layer.

In one embodiment, the analyte is capable of changing the alignment of the liquid crystals in said liquid crystal layer.

In one embodiment, said examination in step c) occurs by visual inspection of the transmission and/or reflection of polarized light or non-polarized light or by transmission and/or reflection measurements with polarized light or with non-polarized light, and examining for a change in such transmission.

In one embodiment, said examination in step c) occurs by measurements of an electrical quantity, and examining for a change in such electrical quantity.

In one embodiment, the method further comprises:
d) verifying that an observed change in transmission or reflection or in electrical quantity is caused by said binding event or the presence of an analyte or the activity of an analyte, preferably at an interface between said liquid crystal layer and said phospholipid layer, and is not the result of a disrupted area of the sensor with no liquid crystal and no phospholipid layer being present, by applying a voltage of direct or alternating current to said first and/or second electrode, and investigating whether this results in a change of detected transmission or reflection of polarized light or measured electrical quantity.

In one embodiment, the applied voltage is in the range of 0.1-25 V sinusoidal/triangular/square signal, and the frequency is in the range from 0 Hz to 1 GHz, preferably 100 Hz to 10 MHz.

In one embodiment, the method further comprises:
b′) increasing the local concentration of the analyte or energizing the analyte at the interface between said phospholipid layer and said sample by electrophoresis, dielectrophoresis, Alternating Current Electroosmosis (ACEO) or Joule heating.

In one embodiment, the method further comprises:
b″) increasing the reaction speed by applying a voltage of direct or alternating current to said first and/or second electrode, wherein the applied voltage is in the range of 0.1-25 V sinusoidal/triangular/square signal, and the frequency is in the range from 0 Hz to 1 GHz, preferably 100 Hz to 10 MHz, more preferably 1 kHz to 1 MHz.

In one embodiment, the binding event takes place in at least one of water or an aqueous solution or in the gas phase.

In one embodiment, the analyte is immobilised on a solid support, such as polymeric beads, or one of the substrates during the binding.

In one embodiment, the presence of an analyte is detected indirectly.

In one embodiment, the presence of an analyte is detected indirectly by detecting the presence of a second analyte, wherein said second analyte is capable of changing the alignment of the liquid crystals in said liquid crystal layer.

In one embodiment a second analyte is binds or reacts with the analyte to be (indirectly) detected.

In one embodiment, the method of the present disclosure is a method of using the sensor device for indirectly detecting the presence of an analyte or the activity of an analyte, and said method comprises the steps:
a) providing a liquid crystal sensor device according to the present disclosure,
b) adding a sample to be analyzed onto the phospholipid layer of said liquid crystal sensor device,
c) examining for a binding event, a second analyte to be detected or the activity of a second analyte, based on changes induced by said binding event, the second analyte or activity of the second analyte, to the alignment of the liquid crystals in said liquid crystal layer.

In one embodiment, the alignment of the liquid crystals in the (surface) liquid crystal layer of the liquid crystal sensor device according to the present disclosure is monitored over time and the change in alignment, if present, is measured over time.

In one embodiment of indirect detecting the presence of an analyte, a slowed down time of alignment change can be seen, which is indicative of presence of the analyte.

The objects of the present disclosure are also solved by a method of using the liquid crystal sensor device of the present disclosure for the screening for compounds that bind to an analyte and/or modify the activity of an analyte, such as inhibitors of microbial toxins.

In one embodiment, said method includes:
a) providing a liquid crystal sensor device according to the present disclosure,
b) providing a sample comprising the analyte,
c) providing at least one compound to be screened for binding to the analyte and/or modifying the activity of the analyte,
d) adding said at least one compound to be screened to the sample comprising the analyte,
e) adding the sample comprising the analyte and said compound onto the phospholipid layer of said liquid crystal sensor device,
f) examining for said analyte or the activity of said analyte, based on changes induced by said binding event, analyte or activity of analyte, to the alignment of the liquid crystals in said liquid crystal layer,
wherein no change of the alignment is indicative that the compound to be screened binds to the analyte and/or modifies the activity of the analyte,
and wherein a change of the alignment is indicative that the compound to be screened does not bind to the analyte and/or does not modify the activity of the analyte.

In one embodiment, the alignment or the change of alignment of the liquid crystals in said (surface) liquid crystal layer of the liquid crystal sensor device according to the present disclosure is monitored over time and the change in alignment, if present, is measured over time.

In a preferred embodiment, less than 0.1% change in transmission or in reflection is observed.

In other embodiments, a cut-off value can be higher or slower than 0.1%.

In one embodiment, said examination in step f) occurs by visual inspection of the transmission and/or reflection of polarized light or non-polarized or by transmission and/or reflection measurements with polarized light or with non-polarized, and examining for a change in such transmission, or said examination in step 0 occurs by measurements of an electrical quantity, preferably by capacitance, resistance or current measurements, and examining for a change in such electrical quantity.

In one embodiment, the method further comprises the step:
d′) verifying that an observed change in transmission or reflection or in electrical quantity is caused by said presence of said analyte or the activity of said analyte, preferably at an interface between said liquid crystal layer and said phospholipid layer, and is not the result of a disrupted area of the sensor with no liquid crystal and no phospholipid layer being present, by applying a voltage of direct or alternating current to said first and/or second electrode, and investigating whether this results in a change of detected transmission or reflection of polarized light or measured electrical quantity.

In one embodiment, the applied voltage is in the range of 0.1-25 V sinusoidal/triangular/square signal, and the frequency is in the range from 0 Hz to 1 GHz, preferably 100 Hz to 10 MHz, more preferably 1 kHz to 1 MHz.

In one embodiment, the method further comprises the step:
b′) increasing the local concentration of the analyte or energizing the analyte at the interface between said phospholipid layer and said sample by electrophoresis, dielectrophoresis, Alternating Current Electroosmosis (ACEO) or Joule heating.

In one embodiment, the method further comprises the step:
b″) increasing the reaction speed by applying a voltage of direct or alternating current to said first and/or second electrode, wherein the applied voltage is in the range of 0.1-25 V sinusoidal/triangular/square signal, and the frequency is in the range from 0 Hz to 1 GHz, preferably 100 Hz to 10 MHz, more preferably 1 kHz to 1 MHz.

In one embodiment, the screening for compounds that bind to an analyte and/or modify the activity of an analyte is performed indirectly.

In one embodiment of the methods of the present disclosure, the alignment or the change of alignment of the liquid crystals in said (surface) liquid crystal layer of the liquid crystal sensor device according to the present disclosure is monitored over time and the change in alignment, if present, is measured over time.

In one embodiment of the disclosure a method of manufacturing a liquid crystal sensor device includes:
a) providing a first substrate,
b) depositing a liquid crystal layer on said first substrate,
c) depositing a phospholipid layer on said liquid crystal layer, optionally comprising at least one recognition moiety.

In one embodiment, a method of manufacturing a liquid crystal sensor device includes, further includes
a′) depositing on said first substrate at least a first electrode, and
a″) depositing at least one of an insulating layer, an alignment layer, and an insulating and alignment layer, to coat said first electrode.

In one embodiment, a method of manufacturing a liquid crystal sensor device includes, further includes
d) placing a second substrate on top of said phospholipid layer to sandwich the phospholipid layer and said liquid crystal layer between said first and second substrate, and to form a gap between said second substrate and said phospholipid layer.

In one embodiment of a method of manufacturing a liquid crystal sensor device includes a second substrate has a second electrode, and wherein the methos further includes facing said second electrode to the phospholipid layer and liquid crystal layer.

In one embodiment if the disclosure, a method to detect the presence of an analyte or the activity of an analyte includes:

adding a sample to be analyzed onto a phospholipid layer of a liquid crystal sensor device,
recording at least one of a binding event, an analyte to be detected and an activity of an analyte, based on changes induced by said binding event, analyte or activity of analyte, to an alignment of liquid crystals in a liquid crystal layer.

In one embodiment, a method to detect the presence of an analyte or the activity of an analyte includes recording a binding event of a binding of the analyte to the recognition moiety.

In one embodiment, a method to detect the presence of an analyte or the activity of an analyte the activity of the analyte is the reaction of the analyte with the recognition moiety.

In one embodiment, a method to detect the presence of an analyte or the activity of an analyte includes (i) at least one of a visual inspection of transmission, a visual inspection of transmission reflection of light, and transmission and/or reflection measurements light, and (ii) at least one of examining for a change in such transmission and measuring an electrical quantity.

In one embodiment, a method to detect the presence of an analyte or the activity of an analyte includes further includes:
b′) increasing the local concentration of the analyte or energizing the analyte at the interface between said phospholipid layer and said sample by electrophoresis, dielectrophoresis, Alternating Current Electroosmosis (ACEO) or Joule heating, and
b″) increasing the reaction speed by applying a voltage of direct or alternating current to said first and/or second electrode, wherein the applied voltage is in the range of 0.1-25 V sinusoidal/triangular/square signal, and the frequency is in the range from 0 Hz to 1 GHz.

In one embodiment of a method to detect the presence of an analyte or the activity of an analyte a binding event takes place in water or an aqueous solution or in the gas phase in which an analyte is present in water, an aqueous solution or in the gas phase, or is immobilised on a solid support, or a substrate.

In one embodiment of a method to detect the presence of an analyte or the activity of an analyte the presence of an analyte is detected indirectly, and the analyte is capable of changing the alignment of the liquid crystals in said liquid crystal layer.

In one embodiment the disclosure includes a method for screening for compounds that bind to an analyte and/or modify the activity of an analyte, that includes:
a) providing a liquid crystal sensor device,
b) providing a sample comprising the analyte,
c) providing at least one compound to be screened for binding to the analyte and/or modifying the activity of the analyte,
d) adding said at least one compound to be screened to the sample comprising the analyte,
e) adding the sample comprising the analyte and said compound onto the phospholipid layer of said liquid crystal sensor device,
f) examining for said analyte or the activity of said analyte, based on changes induced by said binding event, analyte or activity of analyte, to the alignment of the liquid crystals in said liquid crystal layer,
   where no change of the alignment is indicative that the compound to be screened binds to the analyte and/or modifies the activity of the analyte, and where a change of the alignment is indicative that the compound to be screened does not bind to the analyte and/or does not modify the activity of the analyte.

In one embodiment of a method for screening, an analyte is selected from the group consisting of a prokaryotic cell, a procaryotic agent, and a toxin, and the analyte is capable of changing the liquid crystal alignment at said interface between said liquid crystal layer and said phospholipid layer.

In one embodiment of a method for screening, an examining f) occurs by visual inspection of the transmission and/or reflection of polarized light or non-polarized light or by transmission and/or reflection measurements with polarized light or with non-polarized light, and examining for a change in such transmission,

In one embodiment of a method for screening, an examining f) occurs by measurement of an electrical quantity, and examining for a change in such electrical quantity.

In one embodiment of a method for screening, a change of the alignment is a change of an alignment of liquid crystals in a liquid crystal layer.

In one embodiment a method for screening further includes:
d′) verifying that an observed change in transmission or reflection or in electrical quantity is caused by said presence of said analyte or the activity of said analyte, and is not the result of a disrupted area of the sensor with no liquid crystal and no phospholipid layer being present, by applying a voltage of direct or alternating current to said first and/or second electrode, and investigating whether this results in a change of detected transmission or reflection of polarized light or measured electrical quantity.

In one embodiment of a method for screening an applied voltage is in the range of 0.1-25 V sinusoidal/triangular/square signal, and the frequency is in the range from 0 Hz to 1 GHz.

In one embodiment a method for screening further includes at least one of:
b′) increasing the local concentration of the analyte or energizing the analyte at the interface between said phospholipid layer and said sample by electrophoresis, dielectrophoresis, Alternating Current Electroosmosis (ACEO) or Joule heating, and
b″) increasing the reaction speed by applying a voltage of direct or alternating current to said first and/or second electrode, wherein the applied voltage is in the range of 0.1-25 V sinusoidal/triangular/square signal, and the frequency is in the range from 0 Hz to 1 GHz.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1A shows a phospholipid, DOPC, with polar head group and non-polar fatty acid chains; FIG. 1B shows cholesterol; FIG. 1C shows the structure of 5CB, a thermotropic liquid crystal; FIG. 1D shows the structure of ganglioside GM1;

FIG. 2 is a cartoon showing the phospholipid-LC layer formation;

FIG. 3 shows lipid-LC layer formation in the presence of different amounts of GM1 embedded in lipid vesicles (wherein upon lipid-LC layer formation the light transmission decreases.);

FIG. 4 shows the detection of CTB when 0.5% GM1 is embedded in LC-lipid layer;

FIG. 5 shows cholesterol and GM1 embedded lipid-LC layer formation;

FIG. 6 shows the detection of CTB in the presence of 10% cholesterol (referred to as 10 CH in A; B: with cholesterol; C: without cholesterol) (embodiment of Example 1);

FIG. 7 shows red-dye doped LC sensor on interdigitated electrodes (IDEs) (of Example 2);

FIG. 8 shows black-dye doped LC sensor on interdigitated electrodes (IDEs) (embodiment of Example 2);

FIG. 9 shows liquid crystal (5CB) on glass wells with 100 μm diameter (pictures taken during annealing cycle, cooling from 55° C. (5CB in liquid phase) to 21° C. (5CB in LC phase) (embodiment of Example 2);

FIG. 10 shows photos of dye doped gold grids with and without DOPC (embodiment of Example 2);

FIG. 11 shows the definition of reaction times of the embodiment of Example 3; and

FIG. 12 shows the shortening of lipid (DOPC) layer formation and enzyme (PLA1) reaction times when AC20V is applied at different frequencies (embodiment of Example 3).

### DETAILED DESCRIPTION

The term “analyte”, as used herein, refers to a molecule or cell the presence (or absence) or activity of which is to be detected. Examples are procaryotic agents, such as toxins, such as microbial toxins. An analyte, as used herein, may also refer to a cell membrane, alone or as part of a biological cell, such as a prokaryotic cell, e.g. a bacterium. As examples for microbial toxins, Cholera toxin (Vibrio cholerea), heat-labile enterotoxin (E. coli), Pertussis toxin (Bordetella pertussis), Anthrax toxin (Bacillus anthracis), Tetanus toxin (Clostridium tetani), streptococcal and staphylococcal toxins, are mentioned.

The analyte is capable of changing the alignment of the liquid crystals in said liquid crystal layer by one or more of: attachment or binding to the recognition moiety or molecule (such as a receptor, enzyme or antibody), or reaction with the recognition moiety or molecule (such as the receptor, enzyme or antibody), or attachment or binding to the phospholipid layer, or reaction with the phospholipid layer. The analyte preferably has the capability to change the liquid crystal alignment at said interface between said liquid crystal layer and said phospholipid layer.

A second analyte may be included. Preferably the second analyte binds or reacts with the analyte to be (indirectly) detected. The second analyte is preferably selected from the components of a medium (such as broth medium) used to grow/culture/feed the first analyte, or antibiotics or drugs that are effective on the first analyte.

In one embodiment, the presence of an analyte is detected indirectly for example by detecting the presence of a second analyte, wherein said second analyte is capable of changing the alignment of the liquid crystals in said liquid crystal layer. The second analyte can be detected by a binding event which is preferably the binding of the second analyte to the recognition moiety or molecule, such as a receptor, comprised in said phospholipid layer or is the binding of the second analyte to the phospholipid layer. Said activity of the second analyte is preferably the reaction of the second analyte with the recognition moiety or molecule, such as a receptor, comprised in said phospholipid layer or is the reaction of the second analyte with the phospholipid layer.

The term “recognition moiety” or “recognition molecule”, as used herein, refers to a molecule or molecular group that is capable of recognizing, i.e. specifically binding an analyte. In accordance with the present disclosure, such recognition moiety or molecule is not directly attached to the surface of the first substrate. If such recognition moiety or molecule is used in a device according to the present disclosure, it will preferably be comprised in the phospholipid layer of the device. It serves the purpose of specifically binding an analyte, in the vicinity of the liquid crystal layer, as a result of which, the analyte will induce a change in the alignment of the liquid crystal layer which can then be subsequently detected.

As examples for recognition moieties or recognition molecules antibodies, antigens, receptors, transmembrane proteins, enzymes are mentioned. As an example of a receptor, ganglioside GM₁ is mentioned, which for example binds cholera toxin.

The term “not directly attached” means that the recognition moiety is not chemically or physically bonded to the first substrate. The first substrate may however be attached to molecules other than the recognition moiety. For example, the first substrate may by treated with one or more hydrophobicizing or hydrophilicizing agents such that the agent is covalently or ionically bonded to a substrate material such as silicon dioxide, glass and/or borosilicate glass.

The term “binding event” refers to a change in molecular interactions of an analyte with an interaction partner, which may or may not be an analyte. Binding events are, for example, association or dissociation events, e.g. between antibody and antigen, hormone and receptor, protein and receptor, etc. Binding events are for example the binding of the analyte to the recognition moiety or molecule, such as a receptor, comprised in the phospholipid layer. Binding may occur through covalent bonding, ionic bonding, physical bonding, van der Waals forces and combinations thereof.

The term “reaction” refers to a change of a component (such as the analyte, the phospholipid layer, the second analyte) which occurs due to the binding of an analyte with an interaction partner, such as with the recognition moiety or molecule, such as a receptor/antibody/enzyme, comprised in the phospholipid layer, or with the phospholipid layer, wherein such change can be, for example, a (partial) hydrolysis of the phospholipid layer, or a hydrolysis or a chemical modification of the analyte, or a digestion of the second analyte by the analyte etc.

The term “activity” refers to the ability of a component, such as the analyte, to bind, to grow, to undergo changes, to consume, to catalyze or participate in or inhibit e.g. chemical reactions or growth etc. The term “activity” also refers to the extent with which a component, such as the analyte, binds, undergoes changes, consumes, catalyzes or participates in or inhibits e.g. chemical reactions or growth.

The term “phospholipid layer”, as used herein, refers preferably to a monolayer of phospholipids. Multiple layers of phospholipids are also included. The phospholipid layer may include compounds such as cholesterol or other lipids. The cholesterol in the phospholipid layer may function as a receptor or recognition moiety. Preferably the phospholipid layer includes 1 to about 20% (by weight) of cholesterol, preferably about 10 to about 15% (by weight) of cholesterol based on the total weight of the phospholipid components. The at least one recognition moiety or molecule is preferably comprised in the phospholipid layer. When comprised in the phospholipid layer the receptor is preferably a ganglioside GM₁, preferably in an amount of about 0.1% to about 10% (by weight) of GM₁, preferably about 0.5% to about 5% (by weight) of GM₁.

The phospholipid layer preferably comprises one or more compounds selected from DOPC (1,2-dioleoyl-sn-glycero-3-phosphocholine), DPPC (1,2-dipalmitoyl-sn-glycero-3-phosphocholine), DMPC (1,2-dimyristoyl-sn-glycero-3-phosphocholine), DSPC (1,2-distearoyl-sn-glycero-3-phosphocholine), DLPC (1,2-dilauroyl-sn-glycero-3-phosphocholine), 1,2-dimyristoleoyl-sn-glycero-3-phosphocholine (14:1, PC), 1,2-dipalmitoleoyl-sn-glycero-3-phosphocholine (16:1, PC), 1,2-dieicosenoyl-sn-glycero-3-phosphocholine (20:1, PC), 1,2-dierucoyl-sn-glycero-3-phosphocholine (22:1, PC), 1,2-dinervonoyl-sn-glycero-3-phosphocholine (24:1, PC), or combinations thereof.

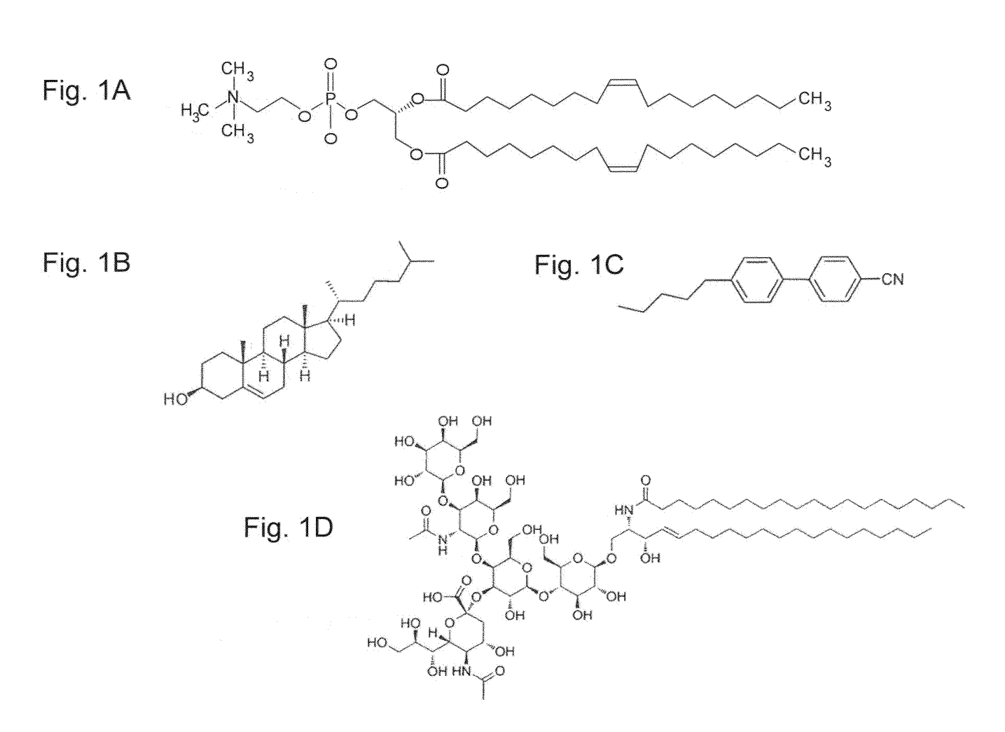

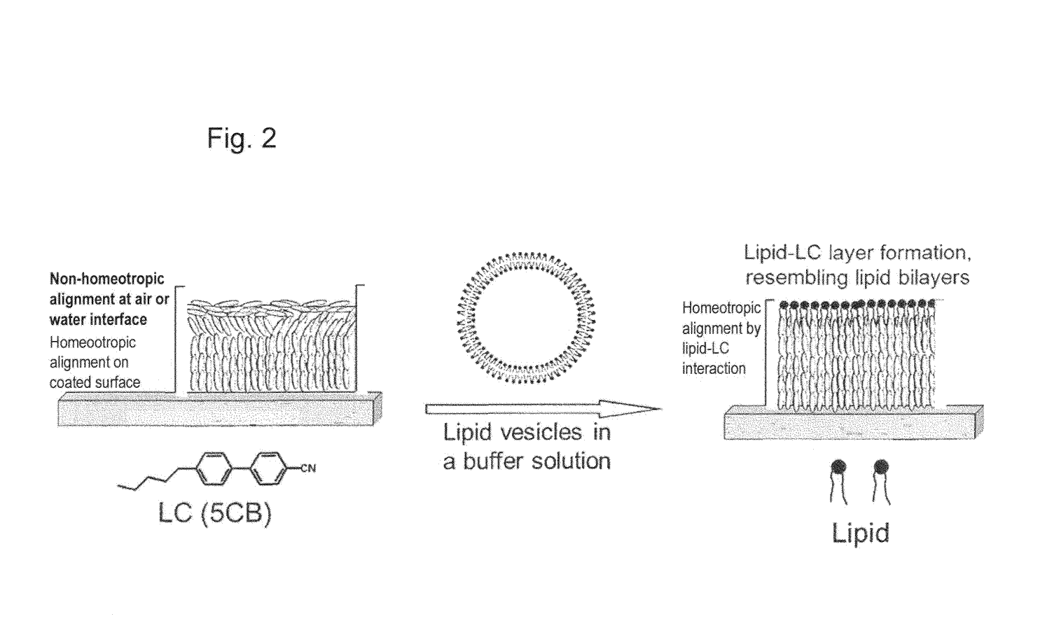

The phospholipid bilayers of cell membranes usually exist in a fluidic state. They can also be referred to as lyotropic liquid crystal state or phase. A lyotropic liquid crystal is a material that forms a liquid crystal phase upon addition of a solvent. The term is mostly used to describe materials composed of amphiphilic molecules with hydrophilic head-group attached to a hydrophobic group. Phospholipids (see FIG. 1A) are an example of such amphiphilic compounds, forming liquid crystal phase in the presence of a solvent, solvent being an aqueous solution for this case. Fluidity of natural cell membranes is essential for the functioning of membrane associated systems. Towards this end, cholesterol (see FIG. 1B) is the essential structural component of a mammalian cell membrane, and it is required to establish the proper membrane permeability and fluidity over the range of physiological temperatures. Cholesterol interacts with the lipid membranes through the interactions between 1) hydroxyl group of cholesterol with the polar head group of phospholipid 2) hydrocarbon chains and the cyclic hydrocarbon (steroid) part of the molecule with the non-polar fatty acid chains of the phospholipid. Through these interactions cholesterol increases the membrane packing. Additionally, cholesterol also plays a significant role in intracellular transport, cell signalling, etc. events. The fluidity of phospholipid bilayers of cell membranes enables the motion and spatial reorganization of the membranes which is essential for many biological processes. The studies presented herein have shown that one can form phospholipid bilayer like fluidic assemblies using thermotropic liquid crystals (like the liquid crystals used in display applications) together with phospholipids. A typical structure of such a thermotropic liquid crystal, 5CB, with a polar head group and a hydrophobic tail is shown in FIG. 1C. A general explanation scheme of a phospholipid-LC bilayer formation is shown in FIG. 2. Forming such a bilayer is well documented in literature (see, for example, Bai, N. L. Abbott, Langmuir 2011, 27, 5719-5738; incorporated herein by reference in its entirety). One starts with a liquid crystal bulk which is aligned homeotropically from one side on a solid substrate that is pre-treated with a specific coating material. On the other hand, the top side of the LC bulk which is in contact with air or water has no homeotropic alignment, the LC molecules stay rather parallel to the bottom substrate. When the LC air/water interface is brought in contact with a solution of lipid vesicles (liposomes) the lipid-LC bilayer forms almost immediately, turning the parallel orientation of LC molecules to homeotropic orientation. This orientation change of liquid crystals can be very well observed at a polarization microscope from the change in light transmittance.

By making such a lipid-LC layer structure close to a natural environment, meaning mimicking the natural cell membranes while employing a thermotropic LC as signal processor, it is now possible to detect bioevents which are associated with cell membranes. One very important group of events that includes the incorporation of cell membranes is the attack of microbial toxins inside the cells. Towards this end, some of the most common and structurally similar protein toxins and their bacterial sources are: Cholera toxin (V. cholerea), heat-labile enterotoxin (E. coli), Pertussis toxin (Bordetella pertussis), Anthrax toxin (Bacillus anthracis), Tetanus toxin (Clostridium tetani), several streptococcal and staphylococcal toxins and so on. What seems to be very common between these toxins is their working mechanisms. They mostly have discreet subunits or domains; 1) a subunit or a domain “A” with a specific enzymatic function and 2) a binding domain, subunit or an oligomer “B” that interacts with the cell membrane receptor.

The present inventors have surprisingly found that by generating a lipid-LC layer that can mimic the natural cell membrane, a device for the effective attachment/binding of the subunit of the toxin to the LC-lipid layer can be provided. The existence of the toxin or the toxic bacteria can thereby be detected by simply looking at the optical changes (change in light transmittance) taking place. This detection is possible only if the toxin is active and this offers a further possibility: By this method/device, also the effectiveness of a drug which is supposed to inactivate or modify the toxin or the respective bacteria can also be detected using this sensing technique/device. The present disclosure, thus, provides a method and a device which is/are useful for: (1) detection of toxins and bacteria, (2) detection of the activity of toxins and bacteria, and (3) screening for drug design and development.

The sensor device of the present disclosure has the following advantages: (1) It is a very simple device. (2) The sensing mechanism does not require any labelling. (3) No complex instrumentation is necessary for the detection. (4) It can be very well integrated together with a microfluidic device. (5) Very quick detection is possible. (6) It exhibits a very good (i.e. sensitive) detection limit. For example, 30 pg/mL or lower CTB can be detected.

In accordance with the present disclosure, the term “electrode” refers to an electrical lead to apply voltage. An electrode may be “interdigitated”, meaning that it has a comb-like shape with two combs lying opposite each other and the respective figures of the combs engaging with each other. Alternatively, an electrode may be a non-interdigitated. An electrode may be transparent or non-transparent. A transparent electrode may, for example, be formed from indium tin oxide (ITO) or from fluorinated tin oxide (FTO). A non-transparent electrode may be reflective and may, for example, be formed from silver (Ag) or aluminium (Al). The reflective electrodes are ideal when one uses the liquid crystal based sensor device in conjunction with a reflective microscope. Preferably the device comprises a second electrode but no first electrode.

The term “insulating layer”, as used herein, is meant to refer to a layer on the electrode that prevents reactions of molecules from other layers, such as the liquid crystal layer, with the electrode. An insulating layer may for example be formed from polyimide, e.g., on one or more of the first and/or second electrodes.

The liquid crystal layer preferably has at least one of a homeotropic alignment, a homogeneous alignment, or no pre-defined alignment. The liquid crystal layer preferably comprises a liquid crystal selected from thermotropic liquid crystals with positive/negative/or no dielectric anisotropy, dual-frequency liquid crystals, discotic and/or lyotropic liquid crystals, and combinations of the foregoing. The liquid crystal layer preferably comprises a single liquid crystal compound or a mixture of two or more different liquid crystal compounds, or a liquid crystal mixture mixed with dopants, such as nanoparticles or small organic molecules, such as bent-core organic molecules. The liquid crystal layer is preferably dye doped, preferably with dichroic dye(s), fluorescent dye(s), or doped with quantum dot(s). The liquid crystal layer preferably comprises at least one of 5CB or MLC6608 liquid crystals.

As used herein, the term “dual-frequency liquid crystal” or “dual-frequency LC” refers to a type of liquid crystal that has positive dielectric anisotropy at low frequency alternating current (AC) voltage, but possesses negative dielectric anisotropy when a high AC voltage is applied. As an example of a dual-frequency LC from Merck called MLA3969, its dielectric anisotropy changes its polarity at around 30 kHz. Hence, the terms “low” and “high”, in the context of AC voltages only refers to the relative positions of the respective voltages with respect to each other. Typically, low can mean 0-100 kHz, high can mean 10-100 MHz, but the concrete values depend on the liquid crystal used.

The term “5CB” refers to 4-cyano 4′-pentyl biphenyl, a single component liquid crystal with positive dielectric anisotropy commercially available from Aldrich. “MLC6608” refers to a trade name of a negative LC mixture commercially available from Merck.

The term “alignment layer” is meant to refer to a layer that can induce a specific alignment of a liquid crystal layer, if the alignment layer is brought in contact with a liquid crystal layer. For example, an alignment layer may be formed of DMOAP (Octadecyldimethyl(3-trimethoxysilylpropyl)ammonium chloride), which induces homeotropic alignment of a liquid crystal layer brought in contact with it. Another example of an alignment layer is a layer of polyimide.

Preferably the device includes an alignment layer which made of a silane such as (octadecyldimethyl(3-trimethoxy-silylpropyl) ammonium chloride) (DMOAP), or a heat/photo-curable polyimide providing for a defined pre-tilt angle of the liquid crystal in the liquid crystal layer or a self assembled monolayer of self assembling compounds, such as thiols, dithiocarbamates, or an obliquely evaporated oxide layer, such as SiO₂ providing for a pre-tilt of the liquid crystal in the liquid crystal layer, depending on the evaporation angle of the oxide.

The term “an insulating layer and/or an alignment layer” is meant to refer to a scenario where, either, both an insulating layer as well as a separate alignment layer are present, or where either an insulating layer is present or an alignment layer is present. In contrast thereto, the term “an insulating and alignment layer” is meant to refer to a scenario where only a single layer is present which has both an alignment as well as an insulating quality. As opposed to the earlier mentioned scenario, the alignment function and the insulating function are both incorporated into one and the same layer in such “insulating and alignment layer”.

As an example of an alignment layer, a polyimide layer may be mentioned, preferably a layer of a heat/photo-curable polyimide. Such a polyimide layer may provide for a defined pre-tilt angle of the liquid crystal in a liquid crystal layer that is in contact with such polyimide layer. The change that may be caused by such polyimide alignment layer may be a change from homeotropic alignment to homogenous alignment, preferably in the range of from 90° to 0°, or the change may be from a homogenous alignment to a homeotropic alignment.

As used herein, a “crossed polarizers” refers to a set of two polarizers having their polarization axis oriented perpendicular to each other. Preferably one polarizer is above the liquid crystal layer and another polarizer is below the liquid crystal layer. Their respective polarization axes are oriented perpendicular to each other. This arrangement allows the measurement of changes in the liquid crystal alignment by measuring changes of transmission or reflection of polarized light. Alternately only at least one polarizer is present above the liquid crystal layer (and no polarizer below the liquid crystal layer). In this arrangement the substrate underneath the liquid crystal layer is a reflective substrate, and the embodiment allows to measure changes in the liquid crystal alignment by measuring changes of the reflection of polarized light, i.e. light that is reflected at the reflective substrate.

In one embodiment, the device further comprises one polarizer only, preferably in the plane of either the first or the second substrate, and wherein the respective other substrate without a polarizer is for use in conjunction with a light source providing polarised light, such as a liquid crystal display device.

The device structure may include a first substrate, a liquid crystal layer on said first substrate, a phospholipid layer on said liquid crystal layer, a second substrate, located opposite to said first substrate and sandwiching said liquid crystal layer and said phospholipid layer between said first and second substrate. Preferably there is a gap between said second substrate and said phospholipid layer, which gap acts as a reaction chamber for receiving a sample to be analysed. Preferably the device includes a second electrode on said second substrate, or a second electrode on said second substrate and an insulating layer on said second electrode, wherein said insulating layer faces said phospholipid layer/liquid crystal layer located on said first substrate.

The first and/or second substrate are preferably solid, more preferably glass or plastic. The first and/or second substrate may be a plastic selected from the group of cycloolefin polymer (COP), cycloolefin copolymer (COC) and polydimethyl siloxan (PDMS).

In yet a further embodiment, the liquid crystal sensor based device according to the present disclosure only comprises one polarizer, which is, preferably, located above the liquid crystal layer, and the substrate below the liquid crystal layer is a transparent substrate which can be then used in conjunction with a light source that provides polarized light.

The term “reaction chamber” is meant to refer to the space where a binding event takes place, or where the analyte or activity of the analyte to be detected is present.

Typically, the reaction chamber in embodiments of the liquid crystal sensor device according to the present disclosure is formed by the space above the phospholipid layer and liquid crystal layer. This space is either open towards the top and encompassed by suitable boundaries at the sides so as to form a containment where an analyte can be received. In other embodiments, this space is formed by the gap between the second substrate and the liquid crystal layer and is encompassed by boundaries at the side. This latter embodiment is a “closed” embodiment. In the open embodiment, the analyte can be simply put on top of the phospholipid layer/liquid crystal layer; in the closed embodiment, the analyte can be put onto the phospholipid layer/liquid crystal layer through specific openings especially designated for such purpose, or it can be put onto the phospholipid layer/liquid crystal layer in an open state, and thereafter the device is closed by lowering the second substrate on top; or, alternatively, the analyte can be put into the reaction chamber by capillary filling it, vacuum filling it or drop casting it in the closed state; yet in an alternative embodiment, the analyte may also be filled into the reaction chamber by using an appropriate pump. The reaction space may include one or more of the phospholipid layer and the liquid crystal layer. For example, an analyte may bind to a receptor that extends into or though the phospholipid layer and/or the liquid crystal layer such that reaction between analyte and receptor occurs at least partially within one or more of the phospholipid layer and the liquid crystal layer.

Preferably the reaction chamber has a depth in the range from 800 nm to 100 μm, preferably from 900 nm to 30 μm, and has a width or diameter, in case of a round chamber, in the range of 1 μm to 1 mm, preferably from 25 μm to 500 μm, and/or the reaction chamber is of glass, plastic or has metal walls, such as gold walls.

The term “transmission measurements with polarized light”, as used herein, refers to a transmission measurement carried out with a detector for polarized light, such as a polarized microscope. The device is typically placed between the crossed polarizers, and the light transmitting through them is measured.

The term “electrophoresis” refers to the movement of charged particles/molecules in a electric field. The electric field can be spatially uniform or not uniform.

As used herein, the term “dielectrophoresis” refers to an effect that induces attractive or repulsive force exerted on polarisable, non-charged substances, by means of a non uniform electric field. Thus, this effect can be used to attract/repel bio-molecules to an electrode by applying AC voltage to an interdigitated electrode (IDE).

The term “alternating current electroosmosis”, “AC electroosmosis”, or “ACEO” refers to an effect that induces a Joule heat resulting in fluid motion of free charges in a non uniform electric field. In this way, randomly floating bio-molecules can be mixed within their solution, shortening the time for a free floating bio-molecule to land on an liquid crystal layer to form a molecular layer (such as lipid layer).

The device may further include one or more of a means or device to measure an electrical quantity which means allows to measure changes in the liquid crystal alignment by measuring changes in such electrical quantity, for example capacitance, resistance, or current; a microfluidic device in fluidic connection with the reaction chamber; a filtering unit to filter any material from the sample that might be larger in size than the analyte of interest, such as a bacterial cell or a microbial toxin, such that said material does not enter the reaction chamber.

A method of manufacturing a liquid crystal sensor device for detecting analytes includes:
a) providing a first substrate,
b) depositing a liquid crystal layer on said first substrate,
c) depositing a phospholipid layer on said liquid crystal layer, optionally comprising at least one recognition moiety/molecule, such as a receptor, and/or cholesterol.

The method for manufacturing a liquid crystal sensor device may further include a step (d) providing a second substrate and putting it on top of said phospholipid layer, such that said phospholipid layer and said liquid crystal layer are sandwiched between said first and second substrate, wherein there is a gap between said second substrate and said phospholipid layer, which gap acts as a reaction chamber for receiving a sample to be analysed.

When a second substrate has a second electrode, step d) is preferably performed such that said second electrode is facing said phospholipid layer/liquid crystal layer.

The method may still further include (a′) depositing on said first substrate at least a first electrode, and a″) depositing an insulating layer and/or an alignment layer, or an insulating and alignment layer, coating said first electrode.

The method of using the liquid crystal sensor device of the present disclosure for detecting the presence of an analyte or the activity of the analyte preferably includes:
e) providing a liquid crystal sensor device according to the present disclosure,
f) adding a sample to be analyzed onto the phospholipid layer of said liquid crystal sensor device,
g) examining for a binding event, an analyte to be detected or the activity of an analyte, based on changes induced by said binding event, analyte or activity of analyte, to the alignment of the liquid crystals in said liquid crystal layer.

The binding event is the binding of the analyte to the recognition moiety or molecule, such as a receptor, enzyme or antibody, comprised in said phospholipid layer, preferably the binding of the analyte to the phospholipid layer.

The activity of the analyte may be represented by the reaction of the analyte with the recognition moiety or molecule, such as a receptor such as a receptor, enzyme or antibody, comprised in said phospholipid layer, preferably the reaction of the analyte with the phospholipid layer.

In one embodiment, said examination in step g) occurs by visual inspection of the transmission and/or reflection of polarized light or non-polarized light or by transmission and/or reflection measurements with polarized light or with non-polarized light, and examining for a change in such transmission, or said examination in step c) occurs by measurements of an electrical quantity, preferably by capacitance, resistance or current measurements, and examining for a change in such electrical quantity.

The method may further comprise (h) verifying that an observed change in transmission or reflection or in electrical quantity is caused by said binding event or the presence of an analyte or the activity of an analyte, preferably at an interface between said liquid crystal layer and said phospholipid layer, and is not the result of a disrupted area of the sensor with no liquid crystal and no phospholipid layer being present, by applying a voltage of direct or alternating current to said first and/or second electrode, and investigating whether this results in a change of detected transmission or reflection of polarized light or measured electrical quantity. Preferably the applied voltage is in the range of 0.1-25 V sinusoidal/triangular/square signal, and the frequency is in the range from 0 Hz to 1 GHz, preferably 100 Hz to 10 MHz, more preferably 1 kHz to 1 MHz.

The method may further comprise one or more of (b′) increasing the local concentration of the analyte or energizing the analyte at the interface between said phospholipid layer and said sample by electrophoresis, dielectrophoresis, Alternating Current Electroosmosis (ACEO) or Joule heating; and (b″) increasing the reaction speed by applying a voltage of direct or alternating current to said first and/or second electrode, wherein the applied voltage is in the range of 0.1-25 V sinusoidal/triangular/square signal, and the frequency is in the range from 0 Hz to 1 GHz, preferably 100 Hz to 10 MHz, more preferably 1 kHz to 1 MHz.

The binding event preferably takes place in water or an aqueous solution or in the gas phase, and wherein the analyte is present in water, an aqueous solution or in the gas phase, or wherein the analyte is immobilised on a solid support, such as polymeric beads, or one of the substrates.

In an aspect of the disclosure in which the method of the present disclosure is a method of using the liquid crystal sensor device of the present disclosurefor indirectly detecting the presence of an analyte or the activity of an analyte, and said method preferably includes:
d) providing a liquid crystal sensor device according to the present disclosure
e) adding a sample to be analyzed onto the phospholipid layer of said liquid crystal sensor device,
f) examining for a binding event, a second analyte to be detected or the activity of a second analyte, based on changes induced by said binding event, the second analyte or activity of the second analyte, to the alignment of the liquid crystals in said liquid crystal layer.

In one embodiment, the alignment of the liquid crystals in the (surface) liquid crystal layer of the liquid crystal sensor device according to the present disclosure is monitored over time and the change in alignment, if present, is measured over time.

In one embodiment of indirect detecting the presence of an analyte, a slowed down time of alignment change can be seen, which is indicative of presence of the analyte.

The term “slowed down time of the alignment change”, as used herein, refers to changes of the alignment of the liquid crystals in the (surface) liquid crystal layer in the liquid crystal sensor device according to the present disclosure which are slower compared to the alignment changes that were taking place before the amount of active component (the component that causes the alignment change, i.e. the second analyte) decreased, due to e.g. binding or reacting to the analyte.

The disclosure also provides a method of using the liquid crystal sensor device of the present disclosure for the screening for compounds that bind to an analyte and/or modify the activity of an analyte, such as inhibitors of microbial toxins. In this aspect the method may include:
a1) providing a liquid crystal sensor device according to the present disclosure,
b1) providing a sample comprising the analyte,
c1) providing at least one compound to be screened for binding to the analyte and/or modifying the activity of the analyte,
d1) adding said at least one compound to be screened to the sample comprising the analyte,
e1) adding the sample comprising the analyte and said compound onto the phospholipid layer of said liquid crystal sensor device,
f1) examining for said analyte or the activity of said analyte, based on changes induced by said binding event, analyte or activity of analyte, to the alignment of the liquid crystals in said liquid crystal layer,
wherein no change of the alignment is indicative that the compound to be screened binds to the analyte and/or modifies the activity of the analyte,
and wherein a change of the alignment is indicative that the compound to be screened does not bind to the analyte and/or does not modify the activity of the analyte.

In one embodiment, the alignment or the change of alignment of the liquid crystals in said (surface) liquid crystal layer of the liquid crystal sensor device is monitored over time and the change in alignment, if present, is measured over time.

The term “change of the alignment”, as used herein in the context of the “screening method”, refers to changes of the alignment of the liquid crystals in the (surface) liquid crystal layer in the liquid crystal sensor device according to the present disclosure upon addition of sample comprising the analyte and candidate compound (in step e1)).

Such change of alignment can be seen in a change of (light) transmission or a change of reflection. In a preferred embodiment such change is preferably at least 0.1%, more preferably at least 0.5%, more preferably at least 1% or more change of transmission or reflection.

The term “no change of the alignment”, as used herein in the context of the “screening method”, refers to the alignment of the liquid crystals remaining essentially the same as before addition of the sample comprising the analyte and the compound to be screened (in step e1)), in particular the same or no essential change in (light) transmission or in reflection, preferably less than 0.1%, more preferably less than 0.05% or less change in transmission or in reflection. In other embodiments, the cut-off value can be higher or slower than the above 0.1%, depending e.g. on the sample and its components, media etc. The cut-off value can also depend on the detector used or the detection method used, such as the sensitivity of said detector/detection method.

For example, in one embodiment, the effectiveness of an antibiotic, a drug or a substance can be tested with respect to deactivating or killing bacteria or a toxin. For example, in case that one compound, such as antibiotic A, is not effective in deactivating or killing the bacteria/toxin, then it leads to an alignment change of the liquid crystals in the liquid crystal layer. Thus, compound A is not effective in deactivating/killing the respective bacteria/toxin. For example, in another case, another compound, such as antibiotic B, is tested which is effective in deactivating or killing the bacteria/toxin, then no alignment change of the liquid crystals in the liquid crystal layer can be seen, because the bacteria/toxin are deactivated. Thus, compound B is effective in deactivating/killing the respective bacteria/toxin.

In one embodiment, said examination in step f1) occurs by visual inspection of the transmission and/or reflection of polarized light or non-polarized or by transmission and/or reflection measurements with polarized light or with non-polarized, and examining for a change in such transmission, or said examination in step f1) occurs by measurements of an electrical quantity, preferably by capacitance, resistance or current measurements, and examining for a change in such electrical quantity.

In one embodiment, the method further comprises the step:
d′) verifying that an observed change in transmission or reflection or in electrical quantity is caused by said presence of said analyte or the activity of said analyte, preferably at an interface between said liquid crystal layer and said phospholipid layer, and is not the result of a disrupted area of the sensor with no liquid crystal and no phospholipid layer being present, by applying a voltage of direct or alternating current to said first and/or second electrode, and investigating whether this results in a change of detected transmission or reflection of polarized light or measured electrical quantity.

In one embodiment, the applied voltage is in the range of 0.1-25 V sinusoidal/triangular/square signal, and the frequency is in the range from 0 Hz to 1 GHz, preferably 100 Hz to 10 MHz, more preferably 1 kHz to 1 MHz.

In one embodiment, the method further comprises the step (b′) increasing the local concentration of the analyte or energizing the analyte at the interface between said phospholipid layer and said sample by electrophoresis, dielectrophoresis, Alternating Current Electroosmosis (ACEO) or Joule heating.

In one embodiment, the method further comprises the step (b″) increasing the reaction speed by applying a voltage of direct or alternating current to said first and/or second electrode, wherein the applied voltage is in the range of 0.1-25 V sinusoidal/triangular/square signal, and the frequency is in the range from 0 Hz to 1 GHz, preferably 100 Hz to 10 MHz, more preferably 1 kHz to 1 MHz.

In one embodiment, the screening for compounds that bind to an analyte and/or modify the activity of an analyte is performed indirectly.

Compound(s) that bind to an analyte and/or modify the activity of an analyte are preferably screened indirectly, such as by detecting the presence or activity of a second analyte, wherein said second analyte is capable of changing the alignment of the liquid crystals in said liquid crystal layer.

As described above, said second analyte is preferably binding or reacting to and/or with the analyte to which the compound(s) to be screened bind to, react to and/or modify the activity of the first analyte.

This embodiment comprises competitive and non-competitive binding of the second analyte and the compound to be screened to the analyte.

In one embodiment of the methods of the present disclosure, the alignment or the change of alignment of the liquid crystals in said (surface) liquid crystal layer of the liquid crystal sensor device according to the present disclosure is monitored over time and the change in alignment, if present, is measured over time.

The present disclosure will now be further described by reference to the following examples which are given to illustrate, not to limit the present disclosure.

### EXAMPLES

In the following, different liquid crystal based sensor device structures according to the present disclosure are described.

### Example 1

### Materials Used

Lipid vesicles: vesicles of DOPC lipid (1,2-dioleoyl-sn-glycero-3-phosphocholine) or vesicles prepared from a mixture of DOPC, GM1, with/without cholesterol.

Gold Grid: 150 mesh (pitch 165 μm) from Plano. The gold grid can be of various sizes, but larger grids are more susceptible to water disruption, and smaller ones require longer time to form lipid layer (LL).

Note: instead of gold grids also other reaction chambers, such as glass or plastic wells, can be applied.

PBS Buffer solution: (Phosphate buffered saline with pH of 7.4). The solution is not restricted to the PBS solution, as it can be anything such as water with different pH values, TBS (Tris-buffered saline) etc.

Liquid crystals: 5CB from Aldrich. Liquid crystal is also not restricted to 5CB but any molecules that have ability to show liquid crystalline phase.

DMOAP (Octadecyldimethyl(3-trimethoxysilylpropyl)ammonium chloride): induces homeotropic alignment of the liquid crystals.

Cholera toxin B (CTB).

### Preparation of Liposomes

### Unilamellar Vesicles

Liposomes (lipid vesicles) are formed when thin lipid films are hydrated and stacks of liquid crystalline bilayers become fluid and swell. The hydrated lipid sheets detach during agitation and self-close to form large, multilamellar vesicles (LMV) which prevents interaction of water with the hydrocarbon core of the bilayer at the edges. Once these particles have formed, reducing the size of the particle requires energy input in the form of sonic energy (sonication) or mechanical energy (extrusion). The general elements of the procedure involve preparation of the lipid for hydration, hydration with agitation, and sizing to a homogeneous distribution of vesicles.

When preparing liposomes with mixed lipid composition, the lipids must first be dissolved and mixed in an organic solvent to assure a homogeneous mixture of lipids. For larger volumes, the organic solvent should be removed by rotary evaporation yielding a thin lipid film on the sides of a round bottom flask. Lipid extrusion is a technique in which a lipid suspension is forced through a polycarbonate filter with a defined pore size to yield particles having a diameter near the pore size of the filter used. Prior to extrusion through the final pore size, LMV suspensions are disrupted either by several freeze-thaw cycles or by pre-filtering the suspension through a larger pore size (typically 0.2 μm-1.0 μm). This method helps prevent the membranes from fouling and improves the homogeneity of the size distribution of the final suspension.

In a typical procedure, stock solution of 10 mM DOPC (1,2-dioleoyl-sn-glycero-3-phosphocholine) in chloroform was prepared. From this solution various molar concentrations of DOPC (0.01 mM, 0.1 mM, 1 mM) were prepared by dissolving them in chloroform. Chloroform was then evaporated with nitrogen gas and solutions were dried for 1 hour in a schlenk line (vacuum line). They were then rehydrated with 5 ml of 0.1 mM PBS (pH 7.0). Small unilamellar vesicles (SUV) were produced by carrying out 3-4 cycles of freezing and heating of the solution with a water bath and liquid nitrogen alternatively. Small aliquots, 500 μl each, were prepared and stored in the freezer at −20° C. When needed, the solutions were thawed and pressed through a polycarbonate membrane, with 100 nm pore, for 21 times using hand held extruder to produce small unilamellar lipid vesicles. These vesicles were used for lipid layer formation.

### Preparation of Liposomes from Mixture of Phospholipid+GM1+Cholesterol

Stock solution of 10 mM DOPC in chloroform, 1 mg of GM1 in 65 μl in chloroform:methanol (6:1) was prepared. From these solutions specific concentrations of DOPC+GM1+cholesterol mixture (90% DOPC [0.01 mM], 0.5% GM1 [0.01 mM] and 9.5% cholesterol [0.01 mM]) or DOPC+GM1 (99.5% DOPC [0.01 mM], 0.5% GM1 [0.01 mM]) were prepared by dissolving them in chloroform.

Chloroform was then evaporated with nitrogen gas and solutions were dried for 1 hour in a schlenk line. They were then rehydrated with 5 ml PBS (pH 7.0). SUVs were produced by carrying out 3-4 cycles of freezing and heating of the solution with a liquid nitrogen and water bath alternatively. Small aliquots, 500 μl each, were prepared and stored in the freezer at −20° C. When needed, the solutions were thawed and pressed through a polycarbonate membrane, with 100 nm pore, for 21 times using hand held extruder to produce small unilamellar lipid vesicles. These vesicles were used for lipid layer formation.

### Substrate Preparation

To coat the substrates for homeotropic alignment of LC, DMOAP solution was prepared by mixing 250 ml of Octadecyldimethyl(3-trimethoxysilylpropyl)ammonium chloride (60% in methanol, AB111261) and 150 ml of deionized water (Millipore). To this solution, the glass substrates were dipped in and held there for about 5 min. After the substrates were taken out of the solution the remaining droplets on the substrate were removed with an air gun. Following, the substrates were dried in a 100° C. vacuum oven for 15 min. Then, gold grids were placed on the DMOAP coated substrate and 2 μl of LC was applied on each gold grid. The excess LC was removed by capillary action using a micro syringe tip. Once after impregnating the gold grid with LC, the substrate was placed in a 50° C. oven for 10 min. The oven temperature was kept above the nematic to isotropic temperature of the LC, in order to realize a uniformly aligned LC. The slides with gold grids were then observed under microscope and any gold grid with no proper alignment of 5CB was discarded.

### Measurement

The cross-polarized microscope brightness was calibrated as follows: 100% transmittance was set when there was no sample and when the polarizer and the analyzer were parallel to each other. 0% transmittance was set when there was no light source. For measurement, the polarizer and the analyzer were placed perpendicular to each other without changing the light intensity. 5 μl lipid solution was applied on the gold grid with partially aligned 5CB and the change in alignment was observed and recorded. In case of lipid solution with GM1 the lipid layer (LL) formation on 5CB was completed in 1-2 minutes. On the other hand, the LL formation from a solution with DOPC, GM1 and Cholesterol required longer time, about 8-10 minutes to complete. After completion of lipid layer formation on the LC (indicated by darker image), the gold grid was washed with PBS to remove any excess of vesicles (lipid with or without GM1 and/or cholesterol). To this lipid layer, 2-5 μl of CTB solution (toxin) in PBS (various concentrations such as 5 μg/L, 10 μg/L etc.) was added and the change in LC alignment was observed and recorded. The observations and recordings were carried out initially for 10-15 min continuously, and then after each hour interval.

### Results and Discussion

From the molecular structure of GM₁ (see FIG. 1D) it can be seen that the non-polar hydrocarbon chains of GM₁ are likely to interact with the non-polar fatty acid chains of the phospholipid, and by this way they will be embedded in the lipid layer. Lipid vesicles (liposomes) with different concentrations of GM₁ were prepared and the lipid-LC layer formation was observed. For this purpose, 0.5%, 2.5% and 5% (weight %) of GM₁ in 0.01 mM DOPC in PBS buffer were used and the lipid vesicles were prepared, as described above.

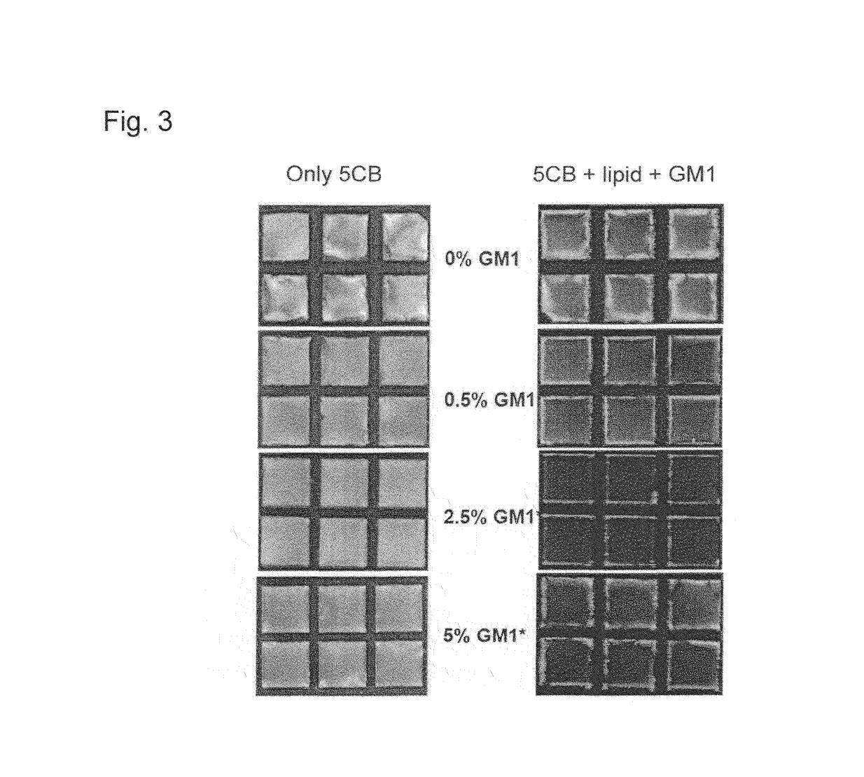

As can be followed from FIG. 3, all the lipid vesicles containing different amounts of GM₁ receptor resulted in lipid-LC layer formation. The orientation change of the LC layer is visible though the change in light transmittance.

### Detection of Cholera Toxin B (CTB)

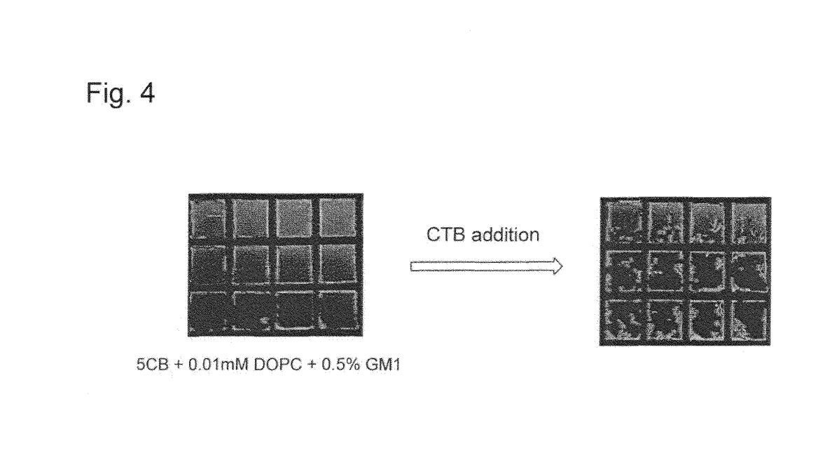

CTB was added on the lipid-LC layers bearing different amounts of GM₁ and it was observed whether there is a light transmittance change happening due to orientation change of LC layer. A change in the orientation of LC layer can be observed. As an example, pictures showing the transmission change in the system where 0.5% GM₁ was embedded in the lipid layer is given in FIG. 4.

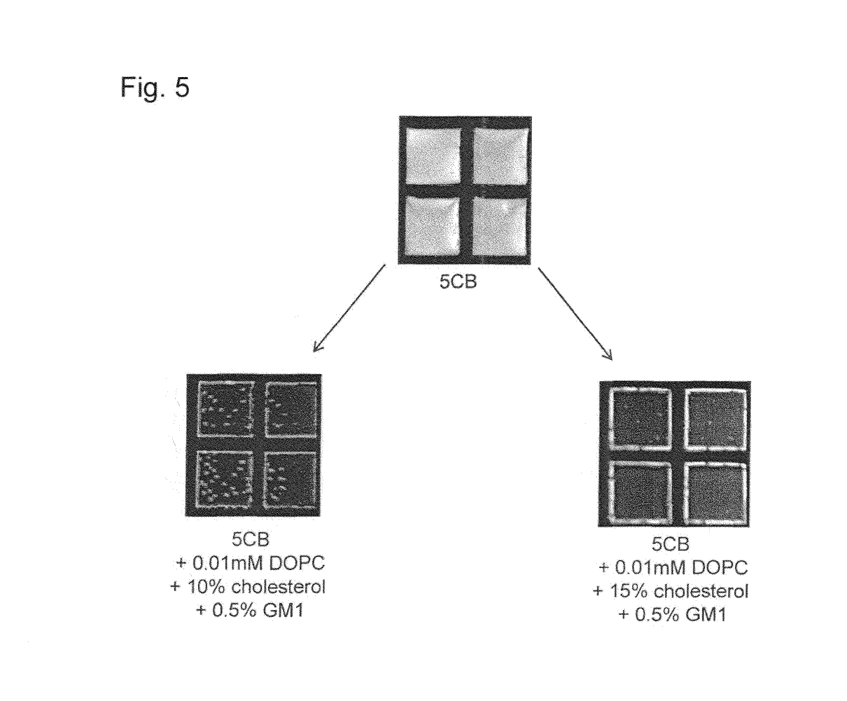

In a natural environment a healthy mammalian cell membrane has cholesterol embedded in the phospholipid bilayer. Based on this knowledge different lipid vesicles with 0.5% GM₁ and different concentrations (10, 15 and 20 weight %) of cholesterol were prepared and then used to form lipid-LC layers using these lipid vesicles on the LC. As can be followed from FIG. 5, lipid-LC layers form when 10 and 15% of cholesterol are embedded in the lipid vesicles.

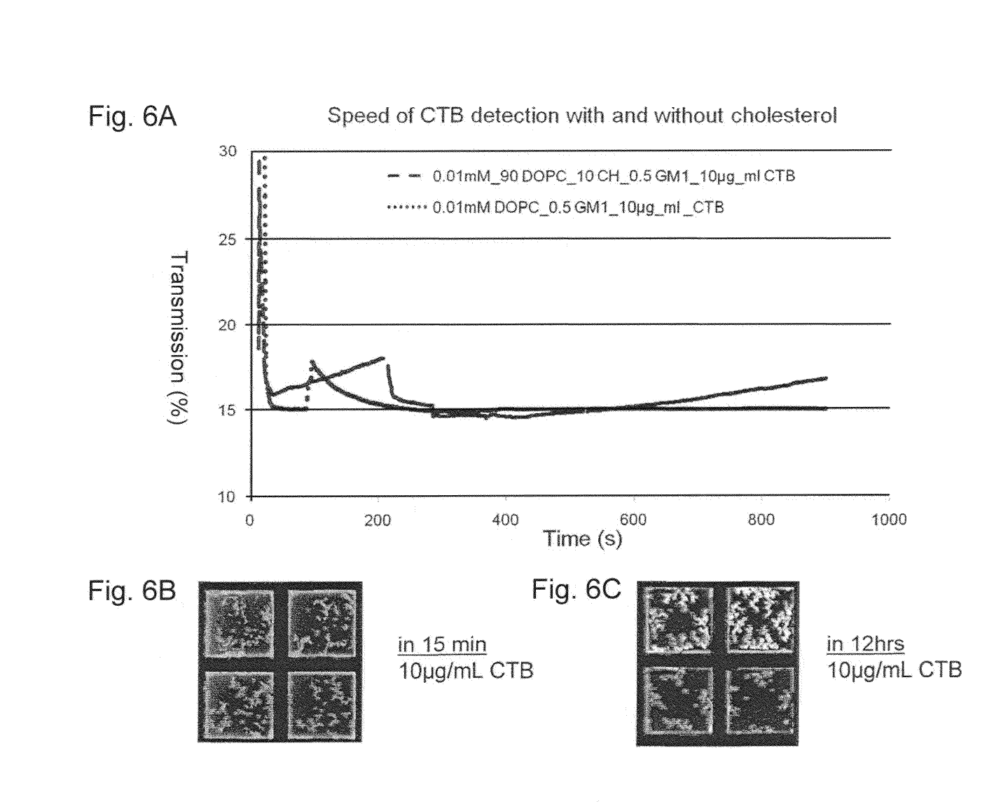

Addition of CTB on the lipid-LC layers with GM₁ and cholesterol embedded in resulted in very clear changes in the light transmittance, see FIG. 6.

### Effect of Cholesterol

To understand the role of cholesterol in our detection, parallel tests were performed where the speed of CTB detection in the presence and absence of cholesterol were determined. It can easily be seen from the pictures (see FIG. 6) that the same amount of CTB can be detected in less than 15 minutes using a sensor system with cholesterol, whereas without cholesterol the same effect is achieved in about 12 hours. Additionally, the transmission-time curves in FIG. 6 A show that LC orientation change had already started after a few minutes in the layers with embedded cholesterol, whereas no change was observable in such a short time when no cholesterol was used.

During the tests, it was seen that CTB loses its activity with time and when that happens no change in the light transmittance could be observed. However, once a fresh batch of CTB is used, the light transmittance change (due to LC orientation change) upon CTB-GM₁ interaction can again be observed.

### Example 2

### A Polarizer/Backlight-Free Dye-Doped LC Based Sensor

This example relates to a LC based sensor, wherein dichroic dyes were incorporated in the LC mixture such that no polarizers and no backlight are required (polarizer-free and backlight-free dye-doped LC based sensor).

### Materials Used:

Target additive: 1 mM DOPC lipid (1,2-dioleoyl-sn-glycero-3-phosphocholine): The target molecule can also be mixed together with additional dopant/additive such as cholesterol, enzymes etc, as long as it has a capability to change the LC alignment at the solution-LC interface.

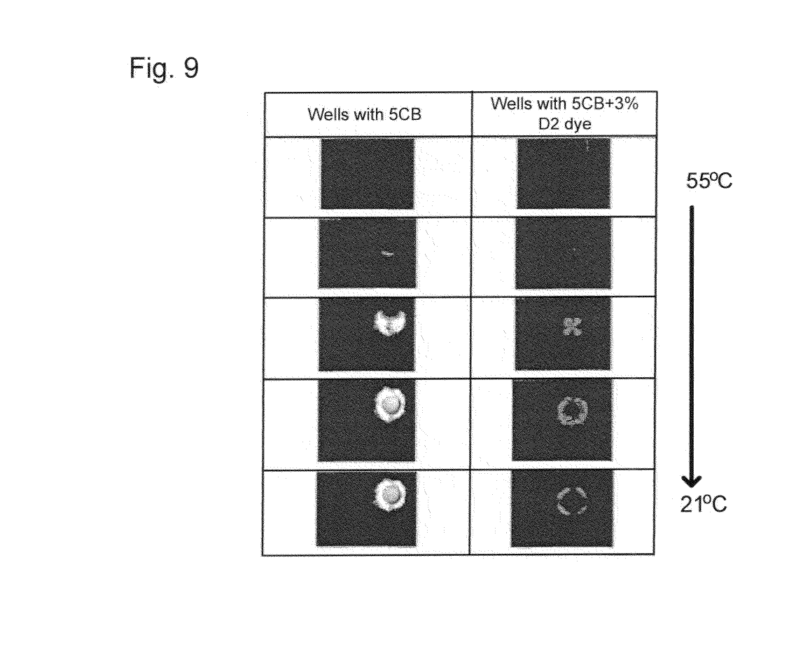

Gold Grid: 300 mesh (pitch 75 μm) from Plano. The gold grid can be of various sizes, but larger grids are more susceptible to water disruption, and smaller ones require longer time to form lipid layer (LL). We can also use glass wells, an example of glass wells filled with dye doped LC is given at FIG. 9.

PBS Buffer solution: [Phosphate-buffered saline with pH of 7.4]. The solution is not restricted to the PBS solution, as it can be anything such as water with different pH values, TBS (Tris-buffered saline) etc.

5CB: Single component LC with positive dielectric anisotropy (positive LC) from Aldrich.

Dichroic Dye: D2 (red azo dye from Merck) and B3 (Black-3 dichroic dye mixture from Mitsubishi Chemical) were used.

Polyimide (PI) coated interdigitated electrode substrates were purchased from EHC, Japan.

DMOAP (Octadecyldimethyl(3-trimethoxysilylpropyl)ammonium chloride): Induces homeotropic alignment to the liquid crystals.

### Sample Preparation:

### Substrate

1. Treat the substrate with ozone plasma (0.1 mbar O₂, 100 W, 1 min), in order to get it react with the silane.
2. Soak the substrate in a solution of silane for more than 5 min.
3. Blow away the solution on the substrates with an air gun, and dry them in a 100° C. vacuum oven for 15 min. Then take out the substrates and allow to cool to room temperature.
4. Place the gold grid on the substrates where IDEs are.
5. Apply 2 μl of 5CB on the gold grid, and remove the excess LC with capillary filling in a micro syringe tip.
6. Place the substrate in a 50° C. oven for 10 min. The temperature should be above the nematic to isotropic temperature of the LC, in order to realize a uniform,homeotropically aligned LC.

### Lipid Solution:

Small unilamellar lipid vesicles were prepared by passing 500 μL lipid solutions (1 mM in PBS) through a 50 nm pore filter with the help of a hand held extruder.

### Measurement

1. For a measurement with polarizers, calibrate the cross-polarized microscope brightness. 100% transmittance was set where there is no sample and when the polarizer and the analyzer are parallel to each other. 0% transmittance was set when there is no light source.
   For a measurement without polarizers, calibration was made that 100% transmittance was set where there is no polarizer and no sample.
2. Attach electrical contacts to the sample, and place it on the microscope stage.
3. Start taking photos and measure the intensity.
4. Apply 5 μl lipid solution.
5. When a stable lipid layer is formed, apply various AC voltages with square signal. (the signal can be sine/triangular wave)

### Results and Discussion

Before the application of the lipid solution, the LC layer appears grey between cross-polarizers and colored without the polarizers. Upon application of the lipid solution, the LC layer turns darker (with polarizers)/brighter (without polarizers). This is due to the induced homeotropic alignment at the solution-LC interface, due to lipid-LC layer formation. Once the transmittance change stopped (when the lipid-LC layer formation is completed) voltage was applied and the transmittance vs time measurements continued.

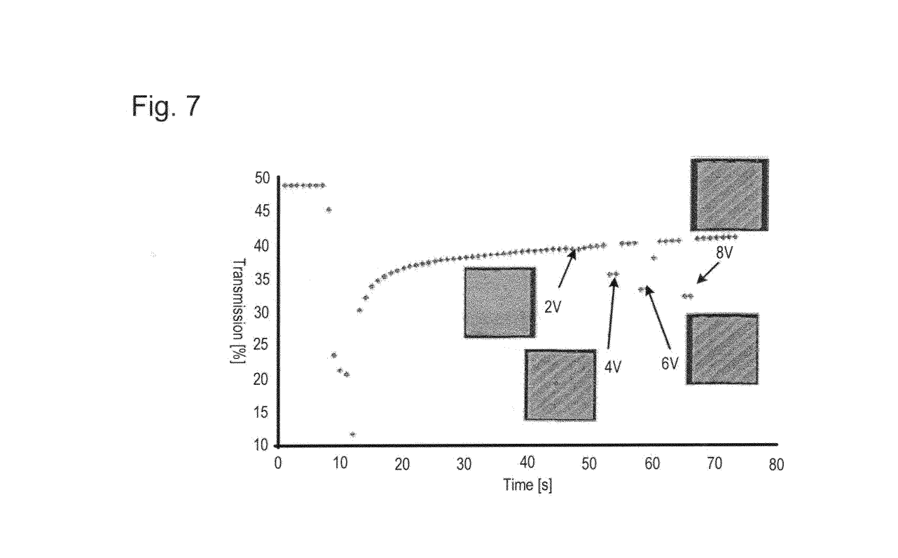

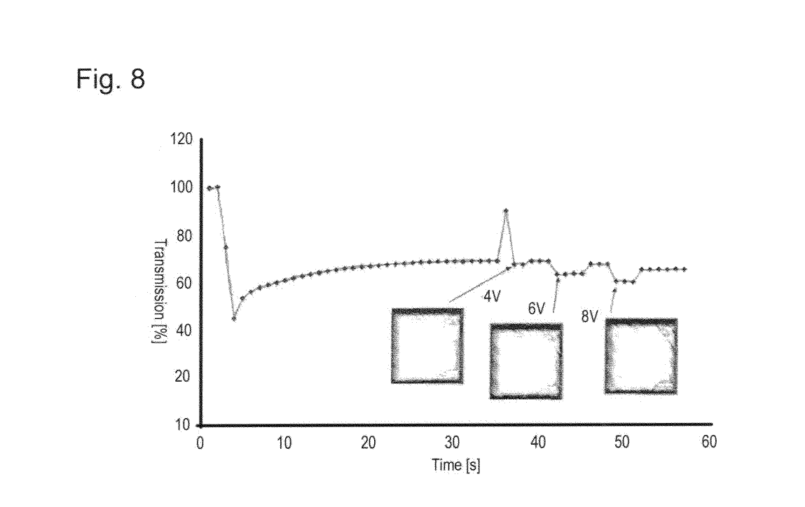

Prior to the measurements, the liquid crystal (5CB) was doped with 3 wt % dichroic dye. This means; dichroic dye doped LC is the sensor component of the system in this example. FIG. 7 and FIG. 8 show the experiments carried out using D2 (red dichroic dye from Merck) and B3 (Black-3 dichroic dye mixture from Mitsubishi Chemicals), respectively. Because the polarizers were not used for these measurements, the transmittance does not decrease as the lipid layer is formed. Instead, due to the homeotropic reorientation of the surface LC and dye, the transmittance increases because the dichroic dye absorbs less when its long axis is parallel to the incident light, i.e. becomes more transparent. The initial transmittance decrease is due to the lipid solution application, and it increases as the lipid layer formation proceeds. Once the increase is saturated, 2, 4, 6 & 8V (1 kHz) were applied and the sudden decrease of the transmittance were recorded. This proves that the dye-doped LCs were not disrupted and still functioning. Use of higher frequency (e.g. MHz) or using a better passivation/insulating layer (e.g. thicker PI layer, SU8, etc) will allow higher voltage application for improved contrast.

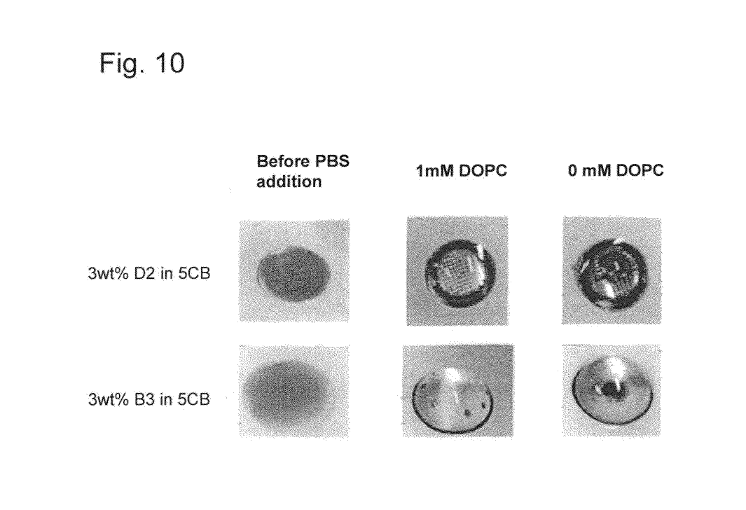

FIG. 10 shows photos of dye doped gold grids before adding PBS solution (buffer solution), and after adding PBS solution with/without lipid (1 mM DOPC). The differences between those grids with and without DOPC were observable even without a microscope and without a backlight. Further improvement in the distinction can be possible by optimizing dye type/concentration, LC type and sensor chamber size and type.

It is also possible to use a fluorescent dye or fluorescent marked LC to achieve polarizer-free LC sensor.

We disclose here the use of dichroic dyes, for a LC based sensor which does not require polarizers, microscope and backlight.

### Example 3

### Speeding Up the LC Sensor Reaction Time by Applying Electric Field

This example relates to a LC based sensor as described in Example 2, wherein the applied voltage is AC 20 V square wave.

### Experimental Condition

LC: 5CB (no dye)
Gold grid: 300 mesh
Solution: 0.5 mM DOPC. 50% diluted PLA1 (phospholipase A1).
Substrate:
   IDE (interdigitated electrode) spin coated by 100 nm SU8 passivation layer, followed by the DMOAP surface treatment.
   Preparation procedure: Annealing (125° C., 30 min)→O₂ plasma→SU8 (10/25%) coating→O₂ plasma DMOAP→Annealing (50° C., 15 min)
Applied voltage: AC 20 V square wave (other waveforms such as triangular/sinusoidal are also possible)

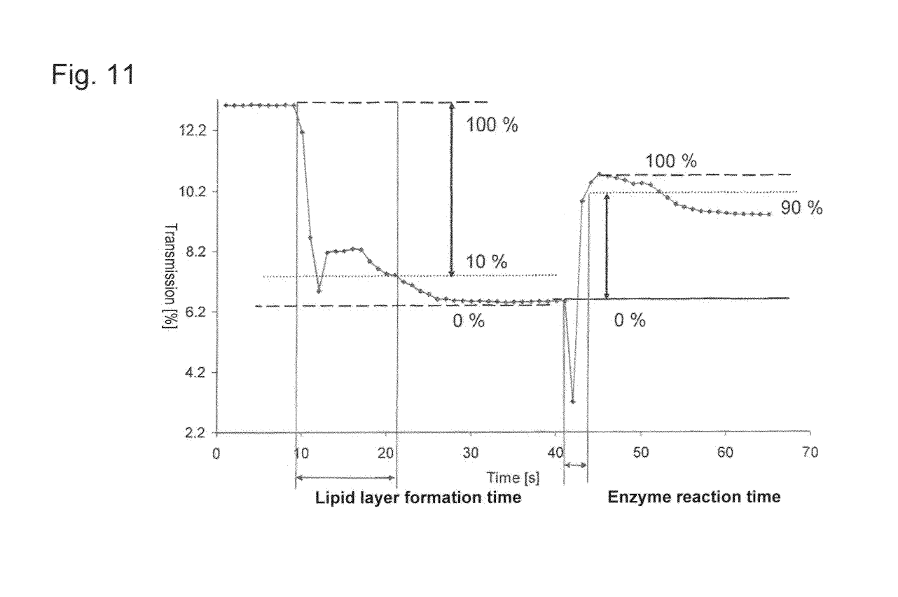

In order to compare the lipid layer formation and enzyme reaction times, a method was used with definitions shown in FIG. 11.

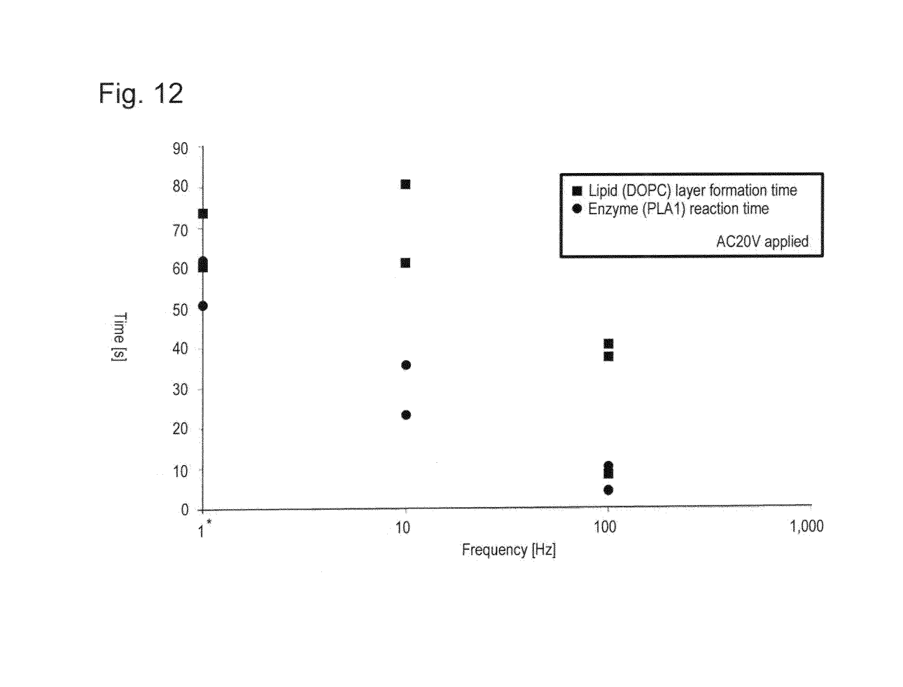

FIG. 12 shows how the lipid layer formation and enzyme reaction times change at various frequencies. 1 Hz data represents 0V (reference) data. The deviation of the data points are still relatively large for the given sample number, but it can be seen that there is an improvement (shortening) of the reaction times. The cause of the improvement appears to be either because of dielectrophoresis of the biomolecules, joule heating of the 5CB LC, or combination of the both.

The features of the present disclosure disclosed in the specification, the claims and/or in the accompanying drawings may, both separately and in any combination thereof, be material for realizing the present disclosure in various forms thereof.

1. A sensor device, comprising:
a first substrate,
a liquid crystal layer on said first substrate,
a phospholipid layer on said liquid crystal layer,
wherein said device further comprises a recognition moiety present in at least one of the liquid crystal layer and the phospholipid layer, and
where the recognition moiety is not attached to the surface of said first substrate.

2. The sensor device of claim 1, wherein the analyte is at least one selected from the group consisting of a prokaryotic cell, a bacterial cell, a procaryotic agent, and a toxin.

3. The device of claim 1, wherein the phospholipid layer comprises the recognition moiety.

4. The device of claim 1, wherein the phospholipid layer comprises at least one recognition moiety selected from the group consisting of a receptor, an enzyme and an antibody.

5. The device of claim 1, wherein the phospholipid layer comprises cholesterol.

6. The device of claim 1, wherein the phospholipid layer comprises cholesterol, in an amount of from 1 to 20% by weight based on the total weight of the phospholipid layer.

7. The device of claim 1, further comprising:
at least a first electrode between said first substrate and said liquid crystal layer, and
at least one of an insulating layer, an alignment layer, and an insulating and alignment layer, present as a coating on the electrode.

8. The device of claim 1, further comprising:
a second substrate, located opposite to said first substrate and sandwiching said liquid crystal layer and phospholipid layer between said first and second substrate.

9. The device of claim 8, having a gap between said second substrate and said phospholipid layer, which gap acts as a reaction chamber for receiving a sample to be analysed.

10. The device of claim 8, wherein said second substrate further comprises:
a second electrode on said second substrate, wherein said insulating layer faces said phospholipid layer/liquid crystal layer located on said first substrate.

11. The device of claim 8, wherein said second substrate further comprises: an insulating layer on said second electrode, wherein said insulating layer faces said phospholipid layer/liquid crystal layer located on said first substrate.

12. The device of claim 1, wherein at least one of the first and the second substrate is a plastic selected from the group consisting of a cycloolefin polymer, a cycloolefin copolymer and a polydimethylsiloxane.

13. The device of claim 1, wherein the liquid crystal layer has at least one of a homeotropic alignment, and a homogeneous alignment.

14. The sensor device of claim 1, wherein the liquid crystal layer comprises a liquid crystal selected from the group consisting of thermotropic liquid crystals with positive dielectric anisotropy, thermotropic liquid crystals with negative dielectric anisotropy, thermotropic liquid crystals with no dielectric anisotropy, dual-frequency liquid crystals, discotic liquid crystals, lyotropic liquid crystals, and combinations of the foregoing.

15. The device of claim 1, wherein the liquid crystal layer comprises a dopant selected from the group consisting of a nanoparticle and a dye.

16. The device of claim 15, wherein the liquid crystal layer comprises a dye selected from the group consisting of a dichroic dye, a fluorescent dye, and a quantum dot(s).

17. The device of claim 1, wherein the phospholipid compounds are selected from the group consisting of 1,2-dioleoyl-sn-glycero-3-phosphocholine, 1,2-dipalmitoyl-sn-glycero-3-phosphocholine, 1,2-dimyristoyl-sn-glycero-3-phosphocholine, 1,2-distearoyl-sn-glycero-3-phosphocholine, 1,2-dilauroyl-sn-glycero-3-phosphocholine, 1,2-dimyristoleoyl-sn-glycero-3-phosphocholine (14:1, PC), 1,2-dipalmitoleoyl-sn-glycero-3-phosphocholine (16:1, PC), 1,2-dieicosenoyl-sn-glycero-3-phosphocholine (20:1, PC), 1,2-dierucoyl-sn-glycero-3-phosphocholine (22:1, PC), 1,2-dinervonoyl-sn-glycero-3-phosphocholine (24:1, PC) or combinations thereof.

18. The device of claim 1, comprising the at least one ganglioside GM1 recognition moiety.

19. The device of claim 8, wherein said first electrode and said second electrode, independently at each occurrence, is a non-interdigitated, plain electrode or an interdigitated electrode (IDE).

20. The device of claim 1, wherein the device further comprises two crossed polarizers below and above the liquid crystal layer respectively.
